(19) United States
(12) Patent Application Publication
(10) Pub. No.: US 2025/0208878 A1
(43) Pub. Date: Jun. 26, 2025

(54) ACCUMULATION APERTURES

(71) Applicant: Advanced Micro Devices, Inc., Santa Clara, CA (US)

(72) Inventor: Nicholas Patrick Wilt, Santa Clara, CA (US)

(73) Assignee: Advanced Micro Devices, Inc., Santa Clara, CA (US)

(21) Appl. No.: 18/390,821

(22) Filed: Dec. 20, 2023

(51) Int. Cl. G06F 9/38; G06F 9/30

(52) U.S. Cl. CPC G06F 9/3834; G06F 9/3004

(57) ABSTRACT

A technique is provided. The technique includes opening an aperture for processing partial results; receiving partial results in the aperture; and processing the partial results to generate final results.

### BACKGROUND

Modern computing hardware is increasingly specialized for performing parallel computing operations. Improvements in this area are important and are constantly being made.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2 illustrates details of the device of FIG. 1 and an accelerated processing device, according to an example;

FIGS. 3A-3E illustrate techniques for providing improved operations for performing reductions;

FIG. 4 illustrates generation of partial results by processing units;

FIG. 5 illustrates reduction of the partial results to the final results by or under the command of the aperture processing controller; and

FIG. 6 is a flow diagram of a method for processing partial results according to an example.

### DETAILED DESCRIPTION

A technique is provided. The technique includes opening an aperture for processing partial results; receiving partial results in the aperture; and processing the partial results to generate final results.

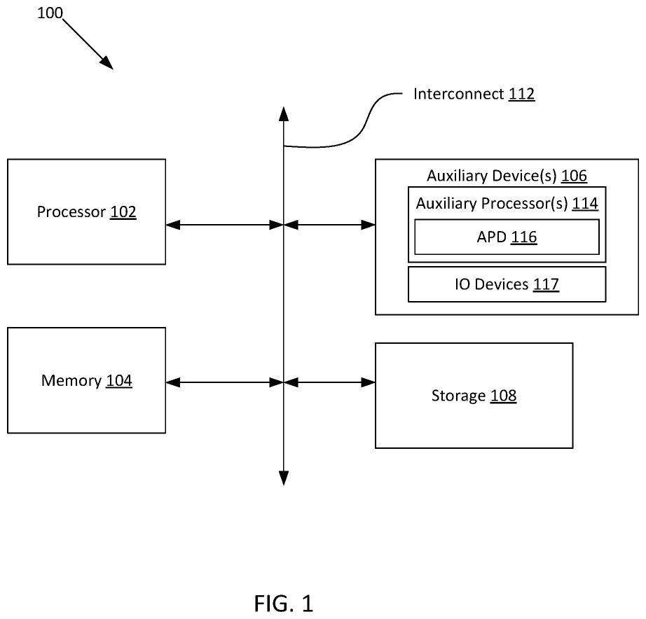

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

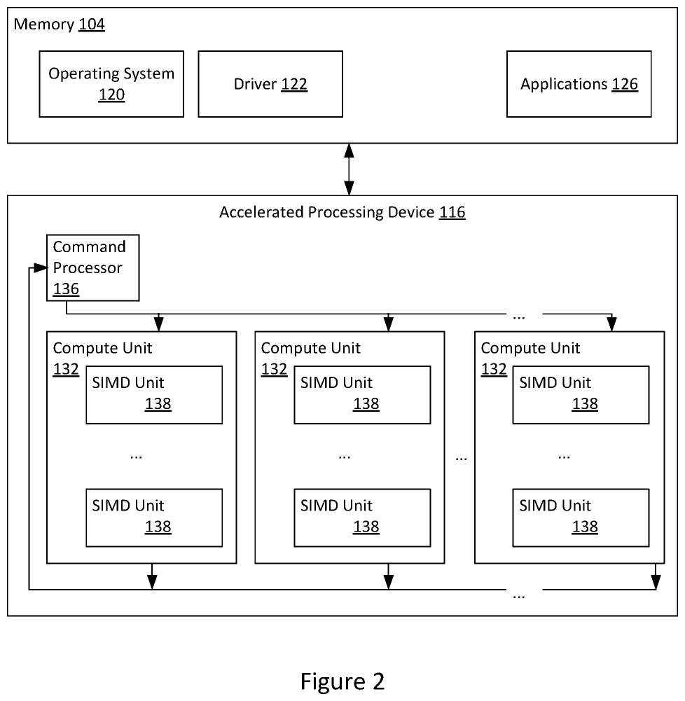

FIG. 2 illustrates details of the device 100 and the APD 116, according to an example. The processor 102 (FIG. 1) executes an operating system 120, a driver 122 (“APD driver 122”), and applications 126, and may also execute other software alternatively or additionally. The operating system 120 controls various aspects of the device 100, such as managing hardware resources, processing service requests, scheduling and controlling process execution, and performing other operations. The APD driver 122 controls operation of the APD 116, sending tasks such as graphics rendering tasks or other work to the APD 116 for processing. The APD driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to a display device based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that are configured to perform operations at the request of the processor 102 (or another unit) in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously (or partially simultaneously and partially sequentially) as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed on a single SIMD unit 138 or on different SIMD units 138.

Wavefronts can be thought of as the largest collection of work-items that can be executed simultaneously (or pseudo-simultaneously) on a single SIMD unit 138. “Pseudo-simultaneous” execution occurs in the case of a wavefront that is larger than the number of lanes in a SIMD unit 138. In such a situation, wavefronts are executed over multiple cycles, with different collections of the work-items being executed in different cycles. A command processor 136 is configured to perform operations related to scheduling various workgroups and wavefronts on compute units 132 and SIMD units 138.

The parallelism afforded by the compute units 132 is suitable for graphics related operations such as pixel value calculations, vertex transformations, and other graphics operations. Thus in some instances, a graphics pipeline, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline (e.g., custom operations performed to supplement processing performed for operation of the graphics pipeline). An application 126 or other software executing on the processor 102 transmits programs that define such computation tasks to the APD 116 for execution.

As described, the APD 116 is a massively parallel device. Many operations performed with such high degree of parallelism include associative operations in which many parallel processing units generate partial results and these results are subsequently combined. In an example, each of multiple processing units performs an operation to generate a partial result and then one or more processing units combines the partial results to obtain a final result. In an example operation, multiple work-items work together to calculate a sum of a collection of numbers. In such an example, each work-item of multiple work-items adds two numbers of the collection of numbers to generate a plurality of partial results. Subsequently, one or more work-items adds the plurality of partial results to obtain a final result. The operation of combining these partial results to obtain a final result is sometimes referred to as a “reduction” or “reductions” herein. The sum operation is used an example and any of a variety of associative operations could alternative be used.

The operations described above are difficult to program for efficiency. Specifically, to use the hardware in an efficient manner, such operations should be programmed to take into account the topology of the memory hierarchy, in order to improve memory access performance characteristics. In an example, work-items that are part of the same wavefront should write partial results into the same memory that is local to a SIMD unit 138, rather than writing the partial results into different local memories or into a global memory. Similarly, reductions that occur on such partial results should occur in a latency sensitive manner, and so on.

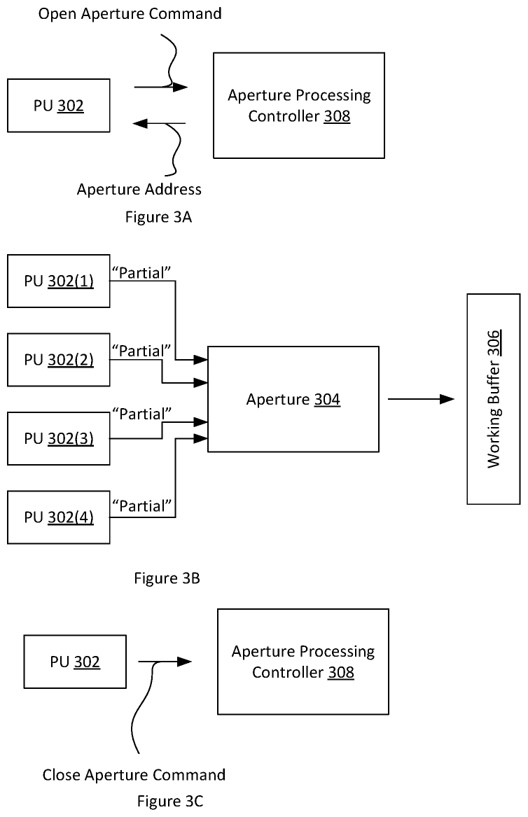

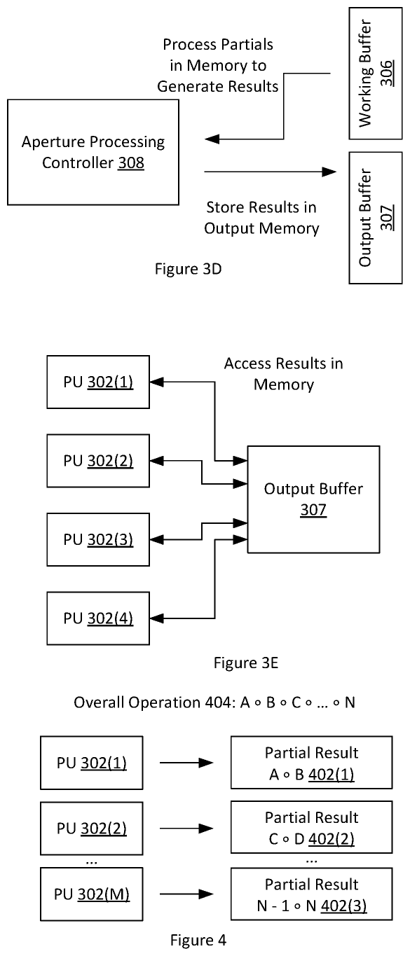

Due to the above, techniques are disclosed herein to provide improved operations for performing reductions. An example of such a technique is presented with respect to FIGS. 3A-3E. FIG. 3A illustrates a first operation. In this operation a processing unit (“PU”) 302 sends an open aperture command to the aperture processing controller 308. The open aperture command is a command that instructs the aperture processing controller 308 to begin operations for performing reductions. In some examples, the open aperture command includes an amount of data involved (e.g., how much data is to be written into the aperture 304), a type of data (e.g., integer, floating point, and bit size for each element), and an operator (e.g., min, max, logical operation, mathematical operation, or the like). In some examples, both an input data type and an output data type are specified by the open aperture command. In some examples, the open aperture command also includes an address for an output buffer 307. The aperture processing controller 308 then “opens” the aperture, meaning that the aperture processing controller 308 configures the aperture to accept and process partial results from processing units 302. In some examples, the operator is specified programmatically (e.g., as a function, shader program, kernel, or as other code).

The aperture processing controller 308 is one of hardware (e.g., a circuit such as a processor, which could include a programmable processing unit, a fixed function processing unit, a configurable logic element, hard-wired analog circuitry, or any other type of circuitry), software, or a combination thereof. In some examples, the aperture processing controller 308 is within the APD 116, is within the processor 102, or is within another element. In some examples, the aperture processing controller 308 is or is part of the command processor 136, a compute unit 132, or a SIMD unit 138. In various examples, the processing units 302 are software or hardware (e.g., a circuit such as a processor, which could include a programmable processing unit, a fixed function processing unit, a configurable logic element, hard-wired analog circuitry, or any other type of circuitry). In some examples, the processing units 302 are lanes of one or more SIMD units 138, are SIMD units 138, are compute units 132, or are any other parallel processing units, such as threads executing in the processor 102.

In some examples, the “aperture” 304 is a set of memory addresses (e.g., the reference one or more memories), or another addressing parameter, that allows the processing units 302 to write partial results into, as shown in FIG. 3B. The aperture processing controller 308 detects writes into the aperture and stores the results in a working buffer 306. In some examples, the working buffer 306 is not present and the aperture processing controller 308 causes the reductions to occur in place. In some examples, the aperture processing controller 308 performs or causes to be performed further processing (“reductions”) on the partial results. In some examples, the aperture processing controller 308 performs or causes to be performed the operation specified in the open aperture command on the partial results, in order to reduce such partial results to the final result. In the case that the operations are associative, these operations can be performed as the processing units 302 write the partial results into the aperture 304. For example, as the aperture processing controller 308 receives partial results, which were generated via an operation (e.g., addition, a logical or bitwise operation, or the like), the aperture processing controller 308 stores such partial results in a working buffer 306 and performs the same operations on such partial results (for example, if the partials are generated using addition, these additional operations would also be addition). In some examples, the entity that performs these additional operations on the partials includes software or hardware (e.g., a circuit such as a processor, which could include a programmable processing unit, a fixed function processing unit, a configurable logic element, hard-wired analog circuitry, or any other type of circuitry). In some examples, the entity includes multiple different processing entities, such as multiple SIMD units 138, compute units 132, processors 102, or the like. It should be understood that the aperture processing controller 308 is, in some examples, distributed throughout the device 100, such as throughout the APD 116 and/or as part of the processor 102 or software executing on the processor 102.

FIG. 3C illustrates sending a close aperture command. A processing unit 302 sends the close aperture command when the PUs 302 are done sending partial results. In an example, an overall operation requires performing an operation on a set of elements. When partial results for all such elements have been generated and written to the aperture 304, a PU 302 sends a close aperture command to the aperture processing controller 308. In response to this, the aperture processing controller 308 closes the aperture.

When the aperture 304 is open, the PUs 302 are permitted to write into the aperture 304 but are not permitted to read from the output buffer 307 (see FIG. 3D). When the aperture 304 is closed, the PUs 302 are not permitted to write into the aperture 304 but are permitted to read from the output buffer 307. In some examples, the PUs 302 are not permitted to read from the output buffer 307 until processing is complete. In some examples, the aperture processing controller 308 closes the aperture after the reductions are complete and after receiving the aperture close command.

FIG. 3D illustrates operations of the aperture processing controller 308 to generate final output results in the output buffer 307 based on the partials received by the PUs 302 (and, e.g., written into the working buffer 306). As stated elsewhere herein, in some examples, generating the final results into the output buffer 307 involves performing the operation specified by the open aperture command on the partials.

In some examples, the operations performed in FIG. 3D are performed at least in part while the aperture is open. In other words, in some examples, the aperture processing controller 308 performs reductions on the partial results as the partial results are being generated and written into the aperture 304. In some examples, the aperture processing controller 308 accumulates the partial results into a final result. In some examples, the operations performed in FIG. 3D are performed at least in part while the aperture is closed. In some examples, the aperture processing controller 308 informs one or more PUs 302 that the reduction operation is complete for the overall operation (i.e., for all the data involved in the operation being performed).

FIG. 3E illustrates access by the PUs 302 of the final results. This accessing represents use of the final results generated by the aperture processing controller 308. In some examples, the PUs 302 wait to access these final results until the aperture processing controller 308 informs the PUs 302 that the reduction operation is complete for the overall operation.

It should be understood that on any given device 100, it is possible for multiple apertures to be open at the same time. For example, it is possible for one set of PUs 302 of a device 100 to be processing data for one aperture while a different set of PUs 302 (or even the same set of PUs 302) of a device 100 are processing data for a different aperture.

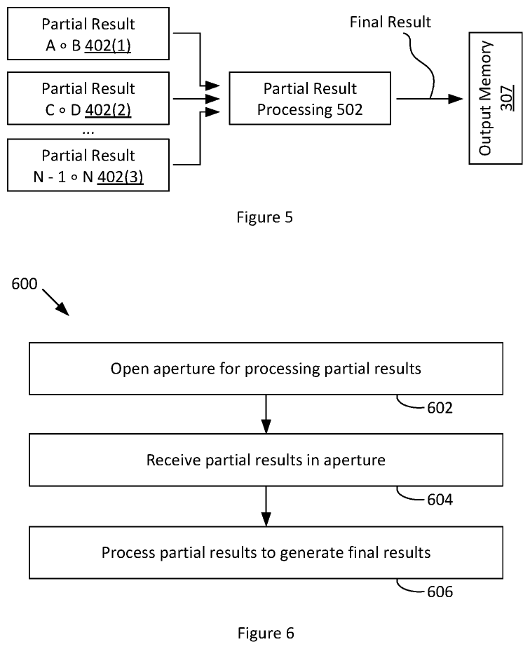

FIGS. 4 and 5 illustrate generation of partial results by the PUs 302 (FIG. 4) and reduction of the partial results to the final results by or under the command of the aperture processing controller 308.

FIG. 4 illustrates generation of partial results 402 by PUs 302 according to an example. An overall operation 404 is illustrated. This operation includes performing an operation, illustrated with the symbol “o,” represents an associative operation to be performed on elements A through N. In some examples, the symbol represents any associative operation that could be performed by the processing units 302. In some examples, the operation is an addition operation, a multiplication operation, a bitwise operation (e.g., OR, AND, XOR, or the like), or any other type of associative operation. In some examples, the operation that the PUs 302 use to generate partial results is not the same as the operation that the aperture processing controller 308 uses to combine the partial results to generate final results. In an example, a matrix multiplication is to be performed. A matrix multiple is performed by generating an element for each slot of a result matrix. For each element, a matrix multiplier generates a dot product for a given row of one input matrix and column of another input matrix. The dot product involves summing the product of different elements of two input vectors. It is possible to independently generate different partial results for each dot product and then to sum those partial results together to get the final dot product results. In some examples, the processing units 302 generate such partial results by multiplying elements of input matrices, and the reduction operation performed by the aperture processing controller 308 involves summing the dot product partial results together to obtain a final result element of the output matrix. In some examples, the processing units 302 each generate partial results by multiplying input elements to obtain partial results and adding such input elements to obtain partial results for the dot product. In other words, in some examples, the partial results generated by each processing unit 302 includes the sum of products of different elements of an input matrix. However, since the entire dot product for a matrix output element has not been generated, the “reduction” requires additional summing to be performed.

FIG. 5 illustrates the partial result processing 502 that “reduces” the partial results 402 to generate a final result that is stored in an output memory 307 and made available for further processing (e.g., by PUs 302). The partial result processing 502 applies the operation specified by the open aperture command (FIG. 3A) to the partial results 402 in order to obtain the final result.

In some examples, the aperture processing controller 308 performs the partial result processing 502. In some examples, the aperture processing controller 308 commands dedicated hardware to perform partial result processing 502. In some examples, the dedicated hardware comprises fixed function hardware, programmable hardware, or other hardware. In some examples, the aperture processing controller 308 performs or commands to perform the partial result processing 502 in response to one or more partial results being written into the aperture 304. In other words, in some examples, the partial result processing 502 is performed as partial results are being written into the aperture 304.

In some examples, the techniques illustrated herein (e.g., with respect to FIGS. 1-5) is implemented at least partially using an application programming interface (“API”) and/or using instructions of an instruction set architecture. In an example, a hardware instruction or API call is available that allows a processing unit 302 to open the aperture (e.g., by executing an open aperture command). In response to such a command, the aperture processing controller 308 triggers processing of the partial results as specified by the command in order to generate final results. In this example, the aperture processing controller 308 or an entity (e.g., software or hardware) configured by the aperture processing controller 308 detects writes of partial results into the aperture 304 and, in response, performs the processing to generate the final results (e.g., by applying the operation specified by the open aperture command). In some examples, a hardware instruction or API call is available that allows a processing unit 302 to close the aperture, thus making the final results available to the processing units 302 (or other entities) within the output buffer 307.

FIG. 6 is a flow diagram of a method 600 for processing partial results according to an example. Although described with respect to the system of FIGS. 1-5, those of skill in the art will recognize that any system configured to perform the steps of the method 600 in any technically feasible order falls within the scope of the present disclosure.

At step 602, the aperture processing controller 308 opens an aperture. In some examples, this opening is performed in response to an open aperture command. In some examples, the open aperture command is sent by a processing unit 302 or another unit. In some examples, the open aperture command specifies how much data is to be written into the aperture 304, the type of data (e.g., integer, floating point, bit size for each element), and an operator, and in some examples the open aperture command includes an address for an output buffer 307. In response to receiving the command, the aperture processing controller 308 opens the aperture. Opening the aperture means enabling the processing units 302 to write into the aperture and also means configuring the aperture processing controller 308 (or whatever hardware or software unit is to perform these operations) to begin processing partial results written into the aperture 304 by applying the operation specified by the open aperture command to the partial results.

At step 604, the aperture 304 receives the partial results. In some examples, the processing units 302 write these partial results into the aperture. In some examples, the aperture is a memory address or memory address range, or is specified by an addressing parameter that is not a memory address (e.g., a bus addressing parameter or some other type of addressing parameter). The aperture processing controller 308 receives the partial results written into the aperture 304.

At step 606, the aperture processing controller 308 performs processing on the partial results to generate final results. In some examples, this processing involves performing the operation specified in the open aperture command on the partial results received at the aperture 304.

In some examples, the processing is performed in a memory locality aware manner. More specifically, the aperture processing controller 308 attempts to minimize memory-related inefficiencies by maintaining the data involved with the reductions in memories that are close to the memory in which the processing units 302 generate the partial results. In an example, a set of processing units 302 that generates a set of partial results are work-items or lanes that work together. These processing units 302 generate partial results in registers of a shared SIMD unit 138 and then write such partial results into the aperture 304. In response to this writing, the aperture processing controller 308 causes one or more of the same processing units 302 to perform one or more reductions, performing the operation specified by the open aperture command on these partial results and storing the subsequent partial result into the registers. As can be seen, regarding the set of data generated in a single local set of registers, reductions performed for such data maintain the data in such registers. Continuing this example, the overall operation includes additional operations to generate additional partial results. These operations are performed in a different SIMD unit 138 than those just mentioned. The lanes in that SIMD unit 138 generate partial results and store them in the registers of that SIMD unit 138, then write such partial results into the aperture 304. The aperture processing controller 308 then causes one of those processing units 302 to perform reductions on the partial results by performing the operation specified by the open aperture command and to store the result in one or more of those registers. The aperture processing controller 308 transfers one or more of the reduced partial results from both SIMD units 138 to a different memory that is accessible by another processing unit 302 that performs further reductions on these reduced partial results. In some examples, this different memory has the lowest latency to either or both of the other processing unit 302 and the SIMD units 138, thus minimizing the total transfer time and access latency of these further reductions. The aperture processing controller 308 continues this processing until the final results for the overall operation are generated. As can be seen, in some examples, the aperture processing controller causes the reductions to be performed in memory and by processing units in a manner that attempts to maximize locality and minimize memory-associated inefficiencies. In examples, for a particular collection of processing units 302 that share a given memory, the aperture processing controller 308 performs reductions by causing one or more of those processing units 302 perform the reductions using that shared memory. In some such examples, the aperture processing controller 308 transfers the results of such partial reductions to a different memory that is the next-highest-level up memory in a memory hierarchy, or to a “sister” memory that is at the same level in the hierarchy. In an example, the aperture processing controller 308 transfers a partially reduced result from the registers of one SIMD unit 138 to the registers of a different SIMD unit 138, where that different SIMD unit 138 already has one or more partially reduced results. Then, the aperture processing controller 308 causes one or more lanes of the different SIMD unit 138 to perform further reductions on the partially reduced results. In some examples, the two SIMD units 138 are in the same compute unit 132 to reduce the amount of time required for transfer of the partially reduced results. A partially reduced result is the result of processing of some but not all partial results for an overall operation using the operation specified by the open aperture command. The aperture processing controller 308 causes the final results to be written into the output buffer 307.

In some examples, once the aperture processing controller 308 generates the final results, any entity, such as any processing unit 302, accesses the data in the output buffer 307 for further processing.

It should be understood that many variations are possible based on the disclosure herein. Although features and elements are described above in particular combinations, each feature or element can be used alone without the other features and elements or in various combinations with or without other features and elements.

Each of the units illustrated in the figures represent hardware circuitry configured to perform the operations described herein, software configured to perform the operations described herein, or a combination of software and hardware configured to perform the steps described herein. For example, the processor 102, memory 104, any of the auxiliary devices 106, the storage 108, the command processor 136, compute units 132, SIMD units 138, aperture processing controller 308, and aperture 304, are implemented fully in hardware, fully in software executing on processing units, or as a combination thereof. In various examples, any of the hardware described herein includes any technically feasible form of electronic circuitry hardware, such as hard-wired circuitry, programmable digital or analog processors, configurable logic gates (such as would be present in a field programmable gate array), application-specific integrated circuits, or any other technically feasible type of hardware.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
opening an aperture for processing partial results;
receiving partial results in the aperture; and
processing the partial results to generate final results.

2. The method of claim 1, wherein the aperture comprises a memory address into which partial results are written.

3. The method of claim 1, wherein receiving the partial results occurs at least partially concurrently with processing the partial results.

4. The method of claim 1, wherein opening the aperture is performed in response to an open aperture command.

5. The method of claim 4, wherein the open aperture command specifies an address of an output buffer, an input data type, an output data type, and an operator.

6. The method of claim 5, wherein the processing comprises storing the final results in the output buffer.

7. The method of claim 5, wherein the operator specifies a fixed operation or a programmatically defined operation.

8. The method of claim 5, wherein the processing comprises applying the operator to the partial results to generate the final results.

9. The method of claim 1, wherein the partial results are generated in parallel.

10. A system comprising:
a memory configured to store data for an aperture; and
a processor configured to:
open the aperture for processing partial results;
receive partial results in the aperture; and
process the partial results to generate final results.

11. The system of claim 10, wherein the aperture comprises a memory address into which partial results are written.

12. The system of claim 10, wherein receiving the partial results occurs at least partially concurrently with processing the partial results.

13. The system of claim 10, wherein opening the aperture is performed in response to an open aperture command.

14. The system of claim 13, wherein the open aperture command specifies an address of an output buffer, an input data type, an output data type, and an operator.

15. The system of claim 14, wherein the processing comprises storing the final results in the output buffer.

16. The system of claim 14, wherein the operator specifies a fixed operation or a programmatically defined operation.

17. The system of claim 14, wherein the processing comprises applying the operator to the partial results to generate the final results.

18. The system of claim 10, wherein the partial results are generated in parallel.

19. A non-transitory computer-readable medium storing instructions that, when executed, cause a processor to perform operations comprising:
opening an aperture for processing partial results;
receiving partial results in the aperture; and
processing the partial results to generate final results.

20. The non-transitory computer-readable medium of claim 19, wherein the aperture comprises a memory address into which partial results are written.
